(19) United States
(12) Patent Application Publication
(10) Pub. No.: US 2014/0261208 A1
(43) Pub. Date: Sep. 18, 2014

(54) ABSORBENT PET PAD

(71) Applicant: THE CLOROX COMPANY, Oakland, CA (US)

(72) Inventors: Elisa Calimano, Pleasanton, CA (US); William Ouellette, Pleasanton, CA (US); Kelsey Kornaus, Pleasanton, CA (US); Jason Fairbanks, Pleasanton, CA (US); Surinder Bains, Pleasanton, CA (US)

(73) Assignee: The Clorox Company, Oakland, CA (US)

(21) Appl. No.: 13/841,890

(22) Filed: Mar. 15, 2013

(51) Int. Cl. A01K 1/01

(52) U.S. Cl. CPC A01K 1/0107
USPC 119/161

(57) ABSTRACT

An absorbent training pad comprising a substantially liquid impermeable bottom layer, a liquid permeable top layer, and an absorbent layer comprising one or more absorbent materials disposed between the bottom and top layers. The absorbent layer includes a main region and a peripheral region with a moat region disposed between the main and peripheral regions in which the moat region is substantially devoid of absorbent material.

### BACKGROUND OF THE INVENTION

1. The Field of the Invention

The present invention relates to absorbent training pads for housebreaking domestic pets. More specifically, the present invention relates to absorbent training pads specially designed to minimize leakage of pet urine beyond the absorbent training pad edges.

2. Description of Related Art

Absorbent training pads for housebreaking domestic pets are generally known in the art. Such absorbent training pads may typically comprise three layers: a liquid-impermeable bottom layer that is in contact with the floor, a liquid-permeable top layer upon which the pet steps and delivers urine, and a layer positioned between the liquid-permeable top layer and the liquid-impermeable bottom layer that is made of an absorbent material.

Many features impact the utility of an absorbent training pad. These features include, but are not limited to the absorbent training pad's ability to capture and hold the liquid pet waste, its ability to attract pets to use the absorbent training pad in the first place, ability to direct pets to deliver urine at an optimal location, odor control, and tactile properties. Prior art efforts to address these issues have included absorbent training pads designed to capture both urine, absorbent training pads that use colors or other visual features (e.g., a “target”) as attractants, and absorbent training pads that use odor suppressants.

One continuing source of frustration to users of such products relates to solving the issue of urine running off the edge of the absorbent training pad. While runoff is not typically an issue if the pet delivers the urine near the center of the pad, often delivery is well off center, near an edge. As such, edge protection and runoff prevention is a continuing problem. Some existing absorbent training pads use a raised berm providing addition all absorbent material near the outer edge of the absorbent training pad. Others compress the absorptive material disposed near the outer edge in an attempt to increase absorptive potential so as to prevent runoff. Such configurations can be more complex and expensive to manufacture, as they require additional materials and manufacturing-steps. It would be an improvement in the art to provide an absorbent training pad that provides improved performance, and which can be mass produced efficiently and at low cost.

### BRIEF SUMMARY OF THE INVENTION

In one embodiment of the present invention, the problem of liquid pet urine escaping the outer edges of the absorbent training pad is solved not by the addition of more absorbent material, but by actually removing some of the absorbent material to create a moat-like structure (that may be devoid of the absorbent material) that divides the absorbent region into a main region and an outer peripheral region. The inventors have surprisingly found that providing such a moat structure directs urine that is near an edge of the absorbent material to quickly spread out allowing it to be more readily absorbed into the peripheral (and main) regions on either side of the moat region. For example, by removing some of the absorbent material to create a moat region that may be substantially devoid of absorbent material, the inventors have found in comparative testing that such a configuration may be comparable to results obtained by increasing the absorptive portion surface area by about 30%. Testing further shows that incidence of edge run off is decreased by as much as 50%, while the amount of runoff (when runoff does occur) may likewise be decreased by as much as 50%. In other words, in testing comparative configurations with and without a moat, total average runoff may be about 4 times less with a moat configuration than without.

One embodiment is directed to an absorbent training pad comprising a substantially liquid impermeable bottom layer, a liquid permeable top layer, and an absorbent layer comprising one or more absorbent materials disposed between the bottom and top layers. The absorbent layer includes a main region and a peripheral region with a moat region disposed between the main and peripheral regions in which the moat region is substantially devoid of absorbent material.

Another embodiment is directed to an absorbent training pad comprising a substantially liquid impermeable bottom layer, a liquid permeable top layer, and an absorbent layer comprising one or more absorbent materials disposed between the bottom and top layers. The absorbent layer includes a main region and a peripheral region with a moat region disposed between the main and peripheral regions in which the moat region is substantially devoid of absorbent material. The pad further includes an edge region substantially surrounding the peripheral region, the edge region being substantially devoid of absorbent material between the top and bottom layers. A plurality of pick-up regions for facilitating pick up and disposal of a used pad without requiring the user to contact liquid absorbed by the pad are also included. For example, such pick-up regions may comprise portions of fee edge region where the width of the pick-up regions is greater than adjacent portions of the edge region, providing greater gripping surface area for a user to pick up the pad for disposal. For example, in embodiments having corners, the corner portions may be configured as pick-up regions to allow a person to pick up a pad by its corners without soiling the hands, or fingers of the person picking it up.

Another embodiment is directed to an absorbent training pad comprising a substantially liquid impermeable bottom layer, a liquid permeable top layer, and an absorbent layer comprising one or more absorbent materials disposed between the bottom and top layers. The absorbent layer includes a main region and a peripheral region with a moat region disposed between the main and peripheral regions in which the moat region is substantially devoid of absorbent material. The inclusion of the moat region results in liquid runoff less often, in a lower amount, or both, as compared to a configuration identically configured but in which the moat region is “filled in” with the absorbent material of the adjacent main and peripheral regions upon delivery of an amount of urine or test liquid (e.g., 45 mL) adjacent an edge (e.g., 2 inches from an edge) of the absorbent layer.

The features and advantages of composition of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE DRAWINGS

The invention will be described and explained with additional specificity and detail through the use of the accompanying drawings in which:

FIG. 1 is a top perspective view of a square or rectangular embodiment of the present absorbent training pad.

FIG. 2 is a cross-sectional view through the pad of FIG. 1 taken along lines 2-2.

FIG. 3 is a top perspective view of another square or rectangular embodiment similar to that of FIG. 1 but not including the “dog-eared” pick up regions.

FIG. 4 is a top perspective view of a round or oval embodiment of the present absorbent training pad.

FIG. 5 is a cross-sectional view through the pad of FIG. 4 taken along lines 5-5.

FIG. 6 is a top perspective view of a kidney or bean-shaped embodiment of the present absorbent training pad.

FIG. 7 is a cross-sectional view through the pad of FIG. 6 taken along lines 7-7.

### DETAILED DESCRIPTION OF THE PREFERRED EMBODIMENTS

### I. Definitions

Before describing the present invention in detail, it is to be understood that the invention is not limited to particularly exemplified configurations, components, dimensions, or other specifics that may, of course, vary, it is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

References herein to “one embodiment”, “one aspect” or “one version” of the invention include one or more such embodiments, aspects or versions, unless the context clearly dictates otherwise.

As used in this specification and the appended claims, the singular forms “a”, “an”, and “the” include plural referents unless the context clearly dictates otherwise.

Unless defined otherwise, all technical and scientific terms used herein have the same meaning as commonly understood by one of ordinary skill in the art to which the invention pertains. Although a number of configurations, components, dimensions and materials similar or equivalent to those described herein can be used in the practice of the present invention, the preferred configurations, components, dimensions and materials are described herein.

In the application, effective amounts are generally those amounts listed as the ranges or levels of ingredients in the description, which follow hereto. Unless otherwise stated, amounts listed in percentage (“%'s”) are in weight percent (based on 100% active) of the active composition alone.

All numbers expressing quantities of ingredients, constituents, dimensions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

### II. Introduction

According to one embodiment, the absorbent training pad of the present invention includes a liquid permeable top layer (e.g., a nonwoven material) through which liquids can pass, a liquid impermeable bottom layer (e.g., polyethylene, polypropylene, another polyolefin or other plastic film) through which liquids substantially cannot pass, and an absorbent layer comprising an absorbent material positioned between the top layer and the bottom layer. The absorbent layer is configured into a main region and a peripheral region with a moat region positioned there-between.

### III. Exemplary Absorbent Training Pads

FIG. 1 shows an embodiment of the claimed absorbent training pad 10 having a square or rectangular shape. FIGS. 4 and 6 show alternative embodiments of the claimed invention that may be rounded or kidney shaped. It will be apparent that the pad 10 may comprise any desired shape, such that the illustrated configurations are merely non-limiting examples. FIGS. 2, 5 and 7 show cross-sectional views, respectively, of each of these various embodiments. The description that follows refers primarily to FIGS. 1 and 2, but should be understood to apply equally to the other Figures as well (unless otherwise indicated) since the primary difference among the three illustrated embodiments is their overall shape.

FIG. 2 is a cross-sectional view through the square or rectangular embodiment of the present invention showing a top layer 16, a bottom layer 18 and an absorbent layer 17 positioned between the top layer 16 and the bottom layer 18. Not shown in the drawings but understood to optionally be present is a layer of adhesive that may be applied to the upper surface of the bottom layer 18 (and/or the lower surfaceof top layer 16) such that the adhesive affixes the top and bottom layers 16 and 18 where no absorbent layer is disposed therebetween. Such an adhesive may also aid in affixing the absorbent layer 17 between bottom layer 18 (at 11 and 12, for example).

The top layer 16 is typically made of a liquid permeable material (e.g., a nonwoven material such as DuPont Spunbond polypropylene). The nonwoven top layer 16 can be selected to have either hydrophobic or hydrophilic properties, and may be colored or be substantially color-free. Non-woven polymers suitable for use may include, but are not limited to polypropylene, polyethylene, other polyolefins, fibrous viscose, rayon, polyester, or combinations thereof. The bottom layer 18 in this embodiment may be a liquid impermeable plastic sheet (e.g., formed from a polyethylene, polypropylene, other polyolefins, blends, etc.). The absorbent layer 17 is this embodiment may be made from a blend of a bleached wood pulp “fluff” (e.g., uncompressed) material and a super absorbent polymer (SAP) such as a cross-linked polyacrylate.

In an embodiment the pad or a layer of the pad (e.g., top layer 16) may include no hydrophilic layer, as such a hydrophilic layer may tend to spread liquid around, potentially causing more runoff.

The top layer 16 and absorbent layer 17 (either or both) can include additives to enhance certain desired properties, for example, either or both of the top layer 16 and the absorbent layer 17 can include a fragrance additive as well as a surfactant to emulsify the fragrance additive. A surfactant within top layer 16 may further aid in promoting absorption of delivered urine. Similarly, other additives may be included in the composition of either or both of the top layer 16 and absorbent layer 17, including odor control agents such as activated carbon, borax, silica and EDTA (ethylenediaroinetetraacetic acid). Either or both the top layer 16 and the absorbent layer 17 may also include an attractant such as a pheromone to encourage pets to make use of the absorbent training pad 10.

Examples of absorbent or super absorbent materials include that may be included in the absorbent layer 17 include, but are not limited to wood or paper pulp (e.g. cellulose), cross-linked polymers such as cross-linked polyacrylate, polyvinyl pyrrolidone, polyethylene, and combinations thereof water soluble inorganic salts or oxides (e.g. sodium borate, magnesium aluminum silicate, alumina, titanium dioxide, silicon dioxide), non-woven polymers (e.g., fibrous viscose, rayon, polyester, or and combinations thereof), crystalline short chain carbohydrates (e.g., mono-saccharides, di saccharides, or combinations thereof), and combinations thereof. Specific examples of crystalline short chain carbohydrates include, but are not limited to sucrose, dextrin, and combinations thereof, and clay like materials such as zeolite, calcium bentonite, sodium bentonite, diatomaceous earth, shale, gypsum, or combinations thereof.

While the illustrated configuration shows a single absorbent layer 17, it will be understood that in some embodiments, more than one (e.g., differently configured) absorbent layers may be included, e.g., such as a layer of materials having hydrophobic or hydrophilic properties, depending on the effect desired. Similarly, the composition of any one of the layers can be altered or enhanced by incorporating hydrophobic or hydrophilic components within them, or by incorporating a surfactant to aid in dispersing the liquid waste.

Referring now to FIG. 1, the absorbent layer of this embodiment has a main region 11 and a peripheral region 12. The main region is the region intended to receive the pet urine (or other waste) and in this embodiment is found roughly centered on the absorbent training pad 10 and taking up approximately one-third to two-thirds (e.g., about one-half) of the area covered by the entirety of the absorbent training pad 10. The main region 11 has a main region outer boundary 19 that may entirely or discontinuously surround the main region 11. Where the main region 11 has such a main region outer boundary 19, the adjacent peripheral region 12 has a peripheral region inner boundary 20. Surrounding the entirety of the peripheral region 12 is a peripheral region outer boundary 21. Surrounding the entirety of the absorbent training pad 10 itself is an outer edge boundary 22. Situated between the peripheral region outer boundary 21 and the outer edge boundary 22 is an edge region 14. Situated between the main region outer boundary 19 and the peripheral region inner boundary 20 is a moat region 13. As such, the main region outer boundary 19 can also be referred to as the moat region inner boundary 19 and the peripheral region inner boundary 20 can also be referred to as the moat region outer boundary 20. Both the edge region 14 and the moat region 13 may be substantially devoid of the absorbent material(s) used to form the absorbent layer 17.

In the embodiments shown, the moat region 13 is a single continuous structure that entirely surrounds the main region 11 of the absorbent layer 17 and travels a path that is substantially concentric with the outer edge 22. Moat region 13 may be generally equidistant at all points from the peripheral region outer boundary 21 (although adjacent pick-up corners 15, the width of peripheral region 12 and/or width of moat region 13 may be somewhat different from the adjacent portions, as shown). In the illustrated embodiment, moat region 13 extends around the entire perimeter of the main region 11. In other embodiments, not shown, the moat region may be discontinuous, (analogous to a dashed or perforated line—where some portions of the moat region 13 may be filled in with absorptive layer 17), or may extend only part way around the perimeter of main region 11. In any case, moat 13 creates an absorbency gap between the main region 11 and the peripheral region 12, which prevents or reduces incidence of liquid penetrating through the peripheral region 12, as it instead is allowed to spread before being absorbed over a larger area.

In another embodiment, moat region 13 may be formed in a serpentine, zig-zag, or other configuration that may deviate from the uniform, generally equidistant path shown in the Figures. Similarly, other embodiments may include providing more than one moat region 13, in that there may two, three or more discrete moat regions, each concentric with, surrounding, encircling or otherwise bracketing the main region 11.

In addition to reducing the incidence of edge runoff, the presence of moat region 13 creates a tactile effect that, may induce the pet to deliver the urine towards the inner portion of pad 10, closer to a center of main region 11, further away from the edges of the absorbent layer.

As noted above, the edge region 14 may be formed such that it is devoid or substantially devoid of the absorbent material used to form the absorbent layer 17. Pet owners can use these edge regions 14 to pick up the absorbent training pad 10 for disposal. In some embodiments, e.g., particularly those including corners such as the square or rectangular embodiment of FIG. 1, or a triangular embodiment (not shown), the edge region 14 at the corners may be formed to be larger by diverting the peripheral region outer boundary so that it rounds, flattens, or bevels the area of the peripheral region 12 that would otherwise form a corner or triangle point. In this way each edge region 14 located at a corner or triangle point is formed into a pick-up region 15 (e.g., where the adjacent peripheral region resembles a beveled or “dog-eared” corner), where the enlarged area devoid or essentially devoid of absorbent material provides pet owners with an easier, larger place to pick up the absorbent training pad 10 for disposal with minimal risk of contacting liquid absorbed by the training pad 10.

It will be appreciated by those of skill in the art that pick-up regions 15 may be formed in absorbent training pads having shapes other than rectangular, square, or triangular. In such other embodiments, scalloped regions may be formed in the peripheral region outer boundary 21 so as to enlarge the adjacent edge region 14 to form a pick-up region 15. Such enlarged, scalloped pick-up regions may be provided in the round, oval, elliptical, or kidney shaped embodiments of FIGS. 4 and 6.

FIG. 3 shows a rectangular or square configuration similar to that of FIG. 1, but that does not include “dog-eared” corner pick-up regions 15.

According to an exemplary method of manufacture, wood pulp (also known as cellulose pulp or fluff pulp) first goes into a hammer mill. The loose pulp is then air-laid (e.g., as a blend with SAP) onto bottom layer 18 or top layer 16 using a screen or mold specially designed for the novel configuration of the absorbent layer 17 described herein featuring a moat region 13 and, in some embodiments, the pick-up region 15. Once the fluffy absorbent layer 17 is placed in the desired configuration relative to one of layers 16, 18, the other layer may be applied and laminated or otherwise affixed, locking the absorbent layer 17 between the top layer 16 and the bottom layer 18. Individual absorbent training pads 10 are then cut, folded and packaged.

The dimensions of the absorbent training pad 10 can vary, as can the relative dimensions of the main region 11, peripheral region 12, moat region 13, edge region 14, and pick-up region 15. In a preferred embodiment, the absorbent training pad 10 is 20 to 24 inches long and 20 to 24 inches wide (e.g., about 21 by about 23.5 inches). The moat region may be from about 0.25 to 2 inches in width (i.e., the distance from the main region outer boundary 19 to the peripheral region inner boundary 20 may be about 0.25 to 2 inches), from about 0.25 to about 1.5 inches in width, or from about 0.25 to about 1 inch in width. The distance from the peripheral region inner boundary 20 to the peripheral region outer boundary 21 (i.e. the width of the peripheral region) may be about 1 to about 3 inches, or about 1.5 to about 2 inches, about 2 times to about 5 times (e.g., about 2 to 3 times) the width of the moat region 13. The peripheral region 12 may have a width that is about 5% to about 15% (e.g., about 10%) a width of the main region 11. A distance from the inside edge 19 of moat region 13 to an outer edge 22 of pad 10 may be from about 2 to about 4 inches (e.g., about 3 inches).

### IV. Examples & Testing Data

Absorbent training pads 10 were made having a rectangular configuration generally as seen in FIG. 1 and having the following components and composition:

| Component | Function | Grams | Weight % |
|---|---|---|---|
| bleached wood pulp fluff | absorption | 24 | 71.09 |
| super absorbent polymer (SAP) | absorption | 2 | 5.92 |
| polyethylene/polypropylene film | bottom layer | 4.5 | 13.25 |
| spunbond or SMS nonwoven | top layer | 2.5 | 7.4 |
| polypropylene | | | |
| Fragrance emulsion | fragrance | 0.25 | 0.74 |
| adhesive | adhesive | 0.5 | 1.59 |
| TOTAL | | 34 | 100 |

In a similar embodiment, an absorbent training pad 10 was made having the following components and composition:

| Component | Function | Grams | Weight % |
|---|---|---|---|
| cellulose pulp | absorption | 20 | 69.7 |
| acrylic acid polymer, sodium salt | absorption | 1 | 3.5 |
| polyethylene/polypropylene film | barrier film | 4.5 | 15.9 |
| spunbond or SMS nonwoven | top sheet | 2.5 | 8.9 |
| polypropylene | | | |
| Fragrance emulsion | fragrance | 0.25 | 0.10 |
| adhesive | adhesive | 0.5 | 1.9 |
| TOTAL | | 28.75 | 100 |

Absorbent training pads so formed had absorbent layer main region dimensions of about 15 inches wide by about 16 inches long, a moat region having a width of about 0.4 to about 0.5 inches, a perimeter region having a width of about 1.5 inches along the sides and about 2 inches in the beveled corners adjacent the pick-up regions, and an outer edge region having a width of about 1 to about 2 inches. The inside edge (19 in FIG. 1) of the moat region was about 3 inches from the outside edge (22 in FIG. 1) of pad 10. The bottom layer was slightly bluish or greenish colored (but still translucent), the top layer was white (but thin enough to be translucent as a whole), and the absorbent layer was white.

An experiment was conducted testing the effectiveness of the manufactured pads (referred to in this section as the “prototype”) against a conventional training pad having no moat feature or equivalent structure (referred to in this section as the “control”). The control was substantially identically configured, but with a single (larger) absorptive region that was substantially equivalent to the dimensions of the main region, the moat and the peripheral region (i.e., the configuration that would result were the moat simply filled in with the absorptive material). In other words, the control included a larger quantity and surface area of absorptive material than the prototype.

A quantity of 45 mL of urine surrogate was applied to a point 2 inches inward from the outer boundary of the absorbent region of the control and the prototype. It was found that out of 24 applications (each to a different pad or different edge so as to avoid double-dosing any one region), 16 (or 67%) resulted in the urine surrogate breaching the outer edge boundary of the control, while only 8 (or 33%) resulted in the urine surrogate breaching the outer edge boundary of the prototype. Thus, the comparative testing showed a 50% reduction in the incidence of edge runoff. In addition, where edge runoff did occur, the control resulted in a mean runoff of 16.9 g, while the prototype resulted in a mean runoff of 8.5 g. In all cases (including where runoff occurred and did not occur), use of the control resulted in a mean runoff of 11.3 g, while the use of the control resulted in a mean runoff of 2.8 g. These results are tabulated in Table 1 below.

TABLE 1

| | | | Total |
|---|---|---|---|
| | | Mean of Runoff Incidences | Runoff Mean |
| Sample | Failure Rate | (not counting 0's) | (counting 0's) |
| Control | 16/24 (33%) | 16.9 g | 11.3 g |
| Prototype | 8/24 (67%) | 8.5 g | 2.8 g |

Thus, the overall effectiveness of the moat configuration was to reduce mean runoff from 11.3 g to 2.8 g, a reduction of about 75% (i.e., mean runoff in the control was about 400% what it was in the prototype).

Such prototype configurations may provide results comparable to results obtained by increasing the absorptive portion surface area by about 30%. The described configurations may also provide equal or superior results as compared to more complex configurations including “berms” or a compressed absorbent layer adjacent the edge (which inherently include a greater amount of absorbent material), as such configurations may inadvertently pull liquid into the compressed or “berm” region, which could then result in runoff.

While the present invention has been described with reference to what are presently considered to be the preferred embodiments, it is to be understood that the invention is not limited to these embodiments. To the contrary, the invention is intended to cover various modifications and equivalent arrangements included within the spirit and scope of the appended claims.

1. An absorbent training pad for use in housebreaking pets, the absorbent training pad comprising:
a substantially liquid impermeable bottom layer;
a liquid permeable top layer; and
an absorbent layer comprising one or more absorbent materials disposed between the bottom layer and the top layer, the absorbent layer having a main region and a peripheral region with a moat region disposed between the main region and the peripheral region, the moat region being substantially devoid of absorbent material.

2. The absorbent training pad of claim 1 wherein the moat region extends around an entire perimeter of the main region.

3. The absorbent training pad of claim 1 wherein the one or more absorbent materials of the absorbent layer comprise a blend of wood pulp and a super absorbent polymer.

4. The absorbent training pad of claim 1 wherein the moat region is substantially concentric within an outer edge boundary of the absorbent training pad.

5. The absorbent training pad of claim 4 wherein the moat region has a width, from about 0.25 inch to about 2 inches.

6. The absorbent training pad of claim 4 wherein the peripheral region has a width from about 1 inch to about 3 inches.

7. The absorbent training pad of claim 4 wherein the peripheral region has an average width that is from about 5% to about 15% a width of the main region.

8. The absorbent training pad of claim 4 wherein the peripheral region has an average width that is from about 2 times to about 5 times a width of the moat region.

9. The absorbent training pad of claim 1 further comprising an edge region substantially surrounding the peripheral region, wherein the edge region is substantially devoid of absorbent material between the top and bottom layers so that the top layer and the bottom layer are disposed adjacent to one another within the edge region.

10. The absorbent training pad of claim 9, the edge region further comprising one or more pick-up regions, the pick-up regions defining a width in the edge region that is greater than adjacent portions of the edge region to facilitate pick up and disposal of a used absorbent training pad whereby a user may grip the pick-up regions to lift the pad off a floor without contacting liquid absorbed by the training pad.

11. The absorbent training pad of claim 1 wherein the absorbent training pad comprises a first moat region and one or more additional moat regions substantially concentric with the first moat region.

12. The absorbent training pad of claim 1 wherein the absorbent training pad is in a shape selected from the group consisting of substantially rectangular, substantially triangular, substantially circular, substantially oval, and substantially kidney-shaped.

13. The absorbent training pad of claim 1 further comprising a pheromone or other animal attractant disposed within the main region.

14. A absorbent training pad for use in housebreaking pets, the absorbent training pad comprising:
a substantially liquid impermeable bottom layer;
a liquid permeable top layer;
an absorbent layer comprising an absorbent material disposed between the bottom layer and the top layer, the absorbent layer having a main region and a peripheral region with a moat region disposed between the main region and the peripheral region, the moat region being substantially devoid of absorbent material;
an edge region substantially surrounding the peripheral region, the edge region being substantially devoid of absorbent material between the top and bottom layers; and
a plurality of oppositely disposed pick-up regions within the edge region of the absorbent training pad, the pick-up regions defining a width that is greater than adjacent portions of the edge region to facilitate pick up and disposal of a used absorbent training pad where a user may grip of two or more oppositely disposed pick-up regions to lift the pad off a floor for disposal without contacting liquid absorbed by the training pad.

15. The absorbent training pad of claim 14 wherein the moat region extends around an entire perimeter of the main region.

16. The absorbent training pad of claim 14 wherein the moat region is substantially concentric within an outer edge boundary of the absorbent training pad.

17. An absorbent training pad for use in housebreaking pets, the absorbent training pad comprising:
a substantially liquid impermeable bottom layer;
a liquid permeable top layer; and
an absorbent layer comprising one or more absorbent materials disposed between the bottom layer and the top layer, the absorbent layer having a main region and a peripheral region with a moat region disposed between the main region and the peripheral region, the moat region being substantially devoid of absorbent material;
wherein the absorbent layer including a main region, a peripheral region, and a moat region therebetween results in liquid runoff less often, in a lower amount, or both than a configuration identically configured but in which the moat region is filled in with the absorbent material of the absorbent layer upon delivering an amount of a test liquid adjacent an edge of the absorbent layer.

18. The absorbent training pad of claim 17 wherein the moat region extends around an entire perimeter of the main region.

19. The absorbent training pad of claim 17 wherein the moat region is substantially concentric within an outer edge boundary of the absorbent training pad.

20. The absorbent training pad of claim 17 further comprising an edge region substantially surrounding the peripheral region, wherein the edge region is substantially devoid of absorbent material between the top and bottom layers so that the top layer and the bottom layer are disposed adjacent to one another within the edge region, the edge region comprising one or more pick-up regions the pick-up regions defining a width in the edge region that is greater than adjacent portions of the edge region to facilitate pick up and disposal of a used absorbent training pad whereby a user may grip the pick-up regions to lift the pad off a floor without contacting liquid absorbed by the training pad.
